(19) United States
(12) Patent Application Publication
(10) Pub. No.: US 2006/0226330 A1
(43) Pub. Date: Oct. 12, 2006

(54) Bar support rack

(76) Inventor: San Chih Yu, Da Li City (TW)

Correspondence Address: CHARLES E. BAXLEY, ESQ., 90 JOHN STREET, THIRD FLOOR, NEW YORK, NY, 10038, US

(21) Appl. No.: 11/103,074

(22) Filed: Apr. 11, 2005

(51) Int. Cl. F16M 13/00; A47G 29/00

(52) U.S. Cl. 248/520; 248/214

(57) ABSTRACT

A bar support rack includes a base, a rotation member rotatably mounted on the base, and a locking member mounted between the base and the rotation member so that the rotation member is angle adjustably located on the base. Thus, the angle between the rotation member and the base can be adjusted so as to adjust the position of the bar mounted on the connecting portion of the rotation member so that the inclined angle of the bar can be adjusted arbitrarily, thereby enhancing the versatility of the bar support rack.

### BACKGROUND OF THE INVENTION

1. Field of the Invention

The present invention relates to a bar support rack, and more particularly to a bar support rack having an angle adjustable function.

2. Description of the Related Art

A conventional bar support rack 10 in accordance with the prior art shown in FIG. 12 comprises a base 11 attached to a wall, and a mounting ring 12 integrally formed on an end of the base 11 for mounting a bar 13. In practice, two bar support racks 10 are attached to the wall, and the bar 13 has two ends each inserted into the mounting ring 12 of the respective bar support rack 10. However, the angle between the base 11 and the mounting ring 12, so that the angle of the mounting ring 12 is fixed and cannot be adjusted. Thus, the angle of the bar 13 supported by the mounting ring 12 is also fixed and cannot be adjusted, thereby limiting the versatility of the conventional bar support rack 10.

### SUMMARY OF THE INVENTION

The present invention is to mitigate and/or obviate the disadvantage of the conventional bar support rack.

The primary objective of the present invention is to provide a bar support rack having an angle adjustable function.

Another objective of the present invention is to provide a bar support rack, wherein the angle between the rotation member and the base can be adjusted so as to adjust the position of the bar mounted on the connecting portion of the rotation member so that the inclined angle of the bar can be adjusted arbitrarily, thereby enhancing the versatility of the bar support rack.

A further objective of the present invention is to provide a bar support rack, wherein the second pivot ear is detachably mounted on the second side of the base, so that the second pivot ear can be replaced when being worn out during a long-term utilization without having to replace the whole bar support rack.

A further objective of the present invention is to provide a bar support rack, wherein the angle between the pivot member and the rotation member can be adjusted so as to adjust the position of the bar mounted on the pivot member so that the inclined angle of the bar can be adjusted arbitrarily, thereby enhancing the versatility of the bar support rack.

A further objective of the present invention is to provide a bar support rack, wherein the angle between the rotation member and the base can be adjusted, and the angle between the pivot member and the rotation member can be adjusted so that the inclined angle of the bar mounted on the pivot member can be adjusted in a two-dimensional manner, thereby enhancing the versatility of the bar support rack.

In accordance with the present invention, there is provided a bar support rack, comprising:

a base;

a rotation member rotatably mounted on the base;

a locking member mounted between the base and the rotation member so that the rotation member is angle adjustably located on the base.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a bar support rack in accordance with the preferred embodiment of the present invention;

FIG. 2 is an exploded perspective view of the bar support rack as shown in FIG. 1;

FIG. 3 is a plan cross-sectional view of the bar support rack as shown in FIG. 1;

FIG. 4 is a perspective view of a bar support rack in accordance with another preferred embodiment of the present invention;

FIG. 5 is a perspective view of a bar support rack in accordance with another preferred embodiment of the present invention;

FIG. 6 is an exploded perspective view of a bar support rack in accordance with another preferred embodiment of the present invention;

FIG. 7 is a perspective view of a bar support rack in accordance with another preferred embodiment of the present invention;

FIG. 8 is an exploded perspective view of the bar support rack as shown in FIG. 7;

FIG. 9 is a schematic plan operational view of the bar support rack as shown in FIG. 7;

FIG. 10 is a perspective view of a bar support rack in accordance with another preferred embodiment of the present invention;

FIG. 11 is a perspective view of a bar support rack in accordance with another preferred embodiment of the present invention;

FIG. 12 is a perspective view of a conventional bar support rack in accordance with the prior art.

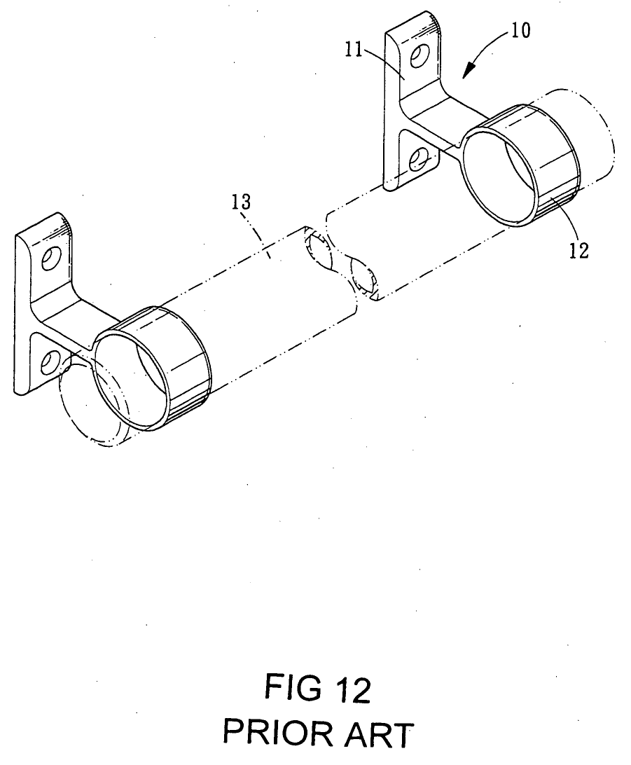

### DETAILED DESCRIPTION OF THE INVENTION

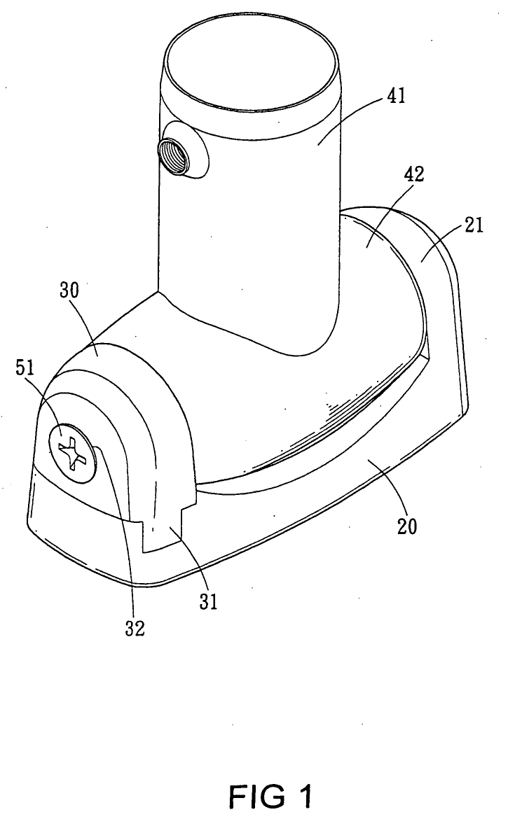

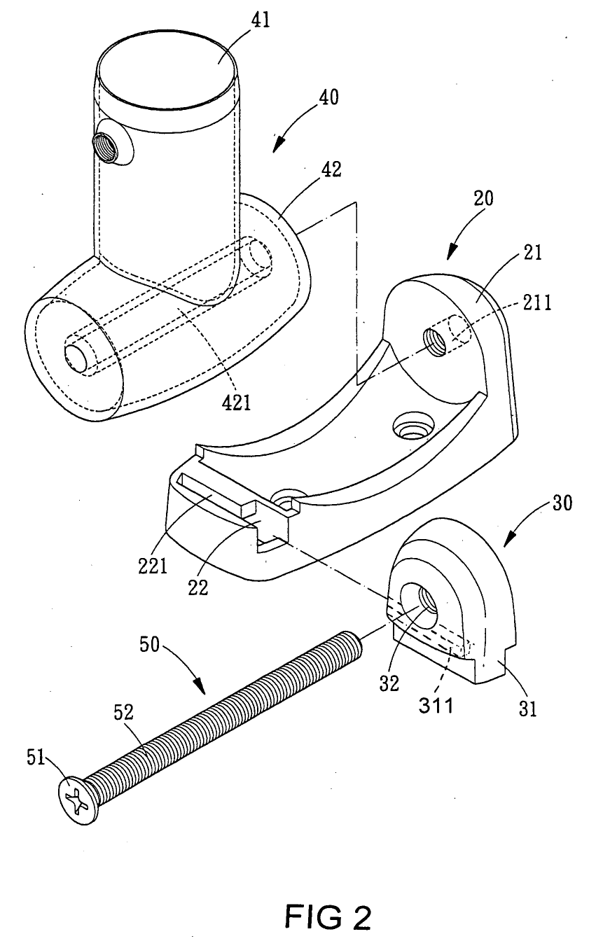

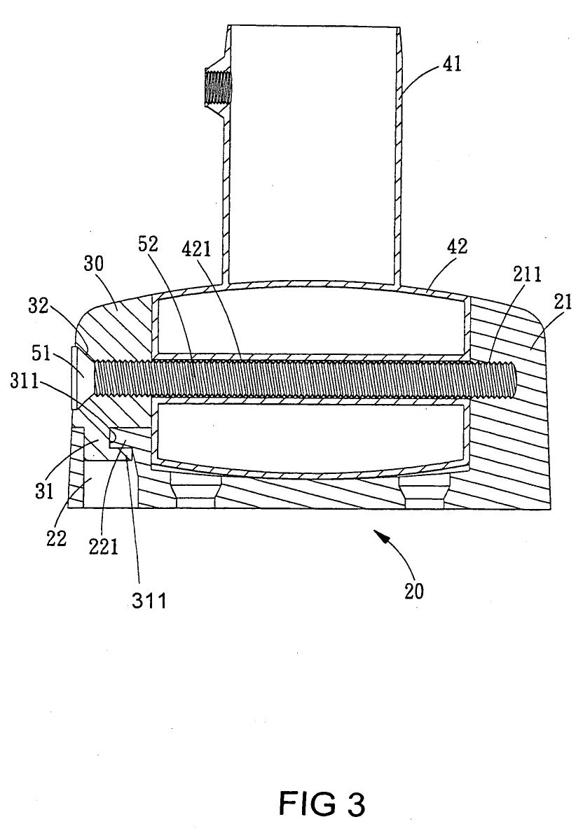

Referring to the drawings and initially to FIGS. 1-3, a bar support rack in accordance with the preferred embodiment of the present invention comprises a base 20, a rotation member 40 rotatably mounted on the base 20, and a locking member 50 mounted between the base 20 and the rotation member 40 so that the rotation member 40 is angle adjustably located on the base 20.

The base 20 has a first side formed with a first pivot ear 21 and a second side formed with a locking slot 22, and the bar support rack further comprises a second pivot ear 30 detachably mounted on the second side of the base 20 and having a locking block 31 mounted in the locking slot 22 of the base 20. The second pivot ear 30 has a side formed with a locking groove 311, and the locking slot 22 of the base 20 has a wall formed with a locking flange 221 locked in the locking groove 311 of the second pivot ear 30 so that the second pivot ear 30 is secured on the base 20. The first pivot ear 21 of the base 20 is formed with a transverse screw hole 211, and the second pivot ear 30 is formed with a transverse stepped screw bore 32 axially aligning with the screw hole 211 of the first pivot ear 21 of the base 20.

The rotation member 40 is a substantially T-shaped hollow body. The rotation member 40 includes a pivot portion 42 pivotally mounted between the first pivot ear 21 of the base 20 and the second pivot ear 30 and a connecting portion 41 mounted on a periphery of the pivot portion 42. The pivot portion 42 of the rotation member 40 is formed with a through hole 421. The connecting portion 41 of the rotation member 40 is a tubular body for mounting a bar (not shown).

The locking member 50 has a threaded rod 52 extended through the screw bore 32 of the second pivot ear 30 and the through hole 421 of the pivot portion 42 of the rotation member 40 and screwed into the screw hole 211 of the first pivot ear 21 of the base 20 to secure the pivot portion 42 of the rotation member 40 between the first pivot ear 21 of the base 20 and the second pivot ear 30. The locking member 50 has an end formed with an enlarged head 51 located in the screw bore 32 of the second pivot ear 30.

In operation, when a user wishes to adjust the angle between the rotation member 40 and the base 20, the locking member 50 is unscrewed, so that the rotation member 40 is rotatable relative to the base 20 so as to adjust the angle between the rotation member 40 and the base 20. The locking member 50 is tightened after the angle adjustment between the rotation member 40 and the base 20, so that the rotation member 40 is fixed on the base 20 by the locking member 50.

Thus, the angle between the rotation member 40 and the base 20 can be adjusted so as to adjust the position of the bar mounted on the connecting portion 41 of the rotation member 40 so that the inclined angle of the bar can be adjusted arbitrarily, thereby enhancing the versatility of the bar support rack.

In addition, the second pivot ear 30 withstands a larger stress when locking the locking member 50. Thus, the second pivot ear 30 is detachably mounted on the second side of the base 20, so that the second pivot ear 30 can be replaced when being worn out during a long-term utilization without having to replace the whole bar support rack.

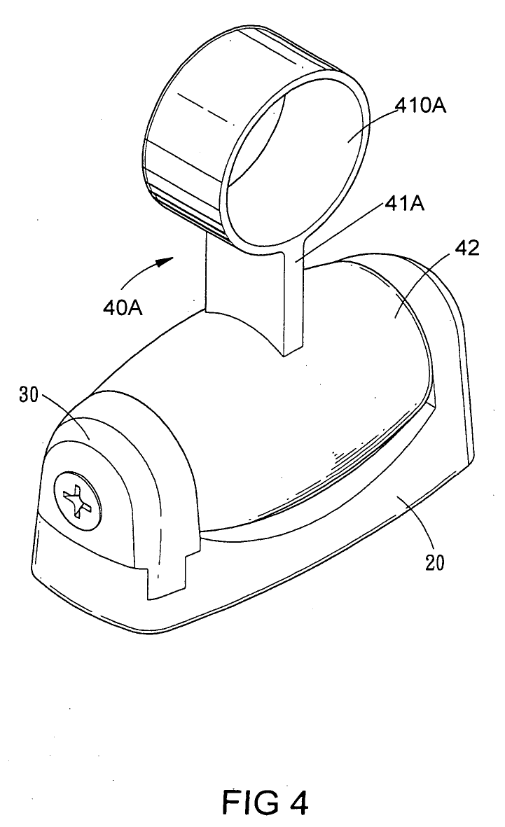

Referring to FIG. 4, the connecting portion 41A of the rotation member 40A has a first end mounted on a periphery of the pivot portion 42 and a second end formed with a mounting ring 410A for mounting a bar (not shown).

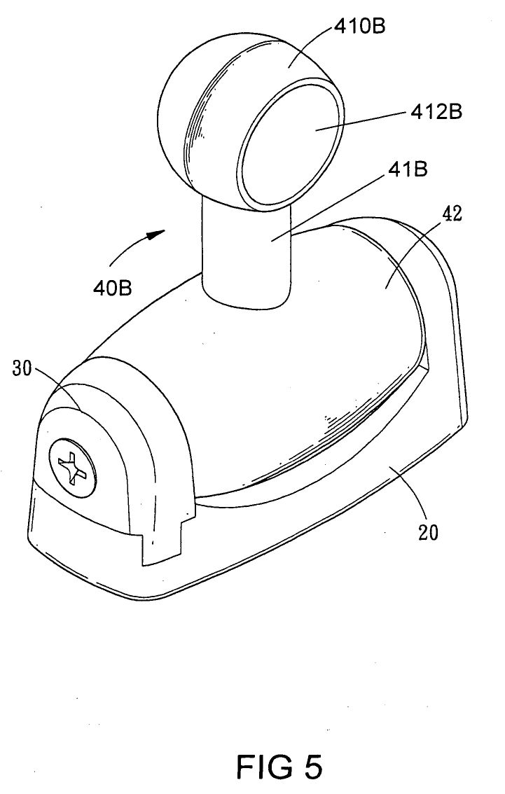

Referring to FIG. 5, the connecting portion 41B of the rotation member 40B has a first end mounted on a periphery of the pivot portion 42 and a second end formed with a mounting section 410B having an inside formed with an arc-shaped recess 412B for mounting a bar (not shown).

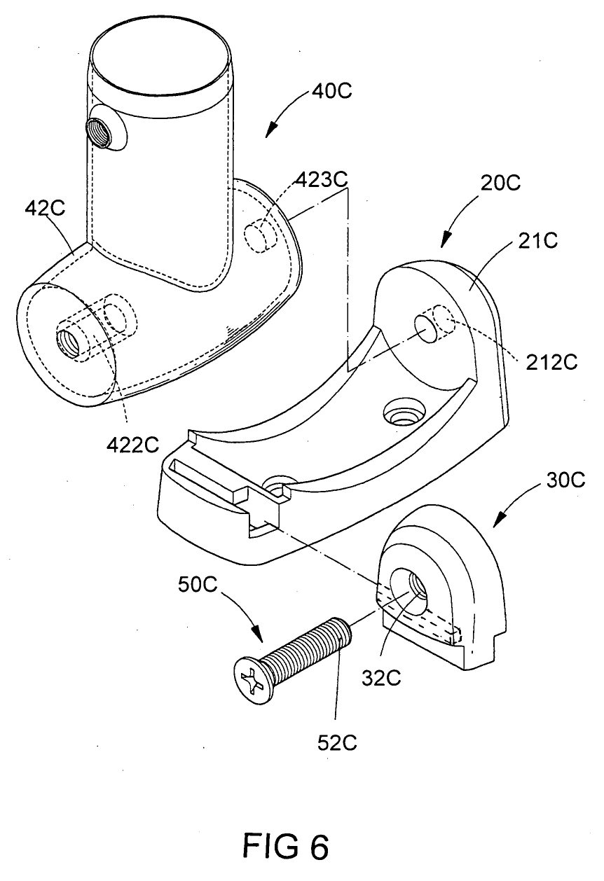

Referring to FIG. 6, the first pivot ear 21C of the base 20C is formed with a transverse mounting hole 212C, and the second pivot ear 30C is formed with a transverse stepped screw bore 32C axially aligning with the mounting hole 212C of the first pivot ear 21C of the base 20C. The pivot portion 42C of the rotation member 40C has a first end formed with a protruding post 423C inserted into the mounting hole 212C of the first pivot ear 21C of the base 20C and a second end formed with a screw bore 422C. The locking member 50C has a threaded rod 52C extended through the screw bore 32C of the second pivot ear 30C and screwed into the screw bore 422C of the pivot portion 42C of the rotation member 40C to secure the pivot portion 42C of the rotation member 40C between the first pivot ear 21C of the base 20C and the second pivot ear 30C.

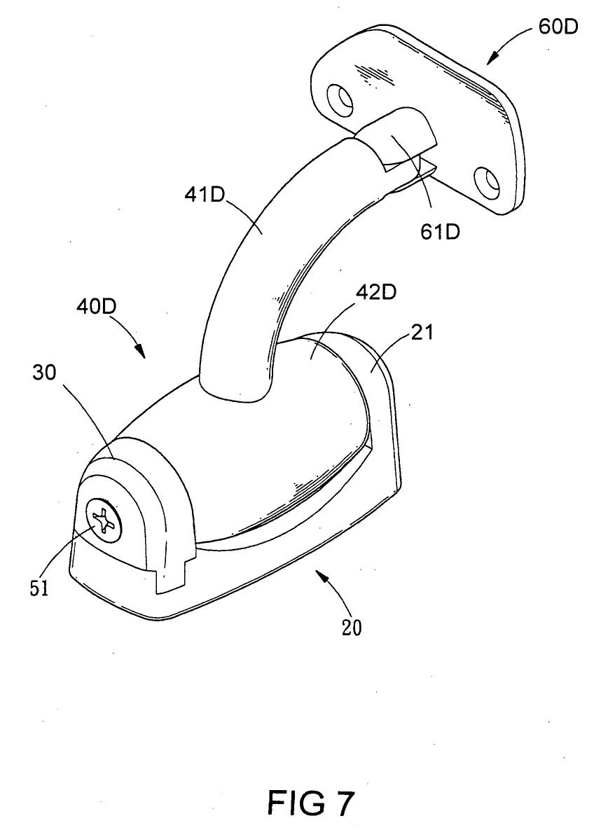

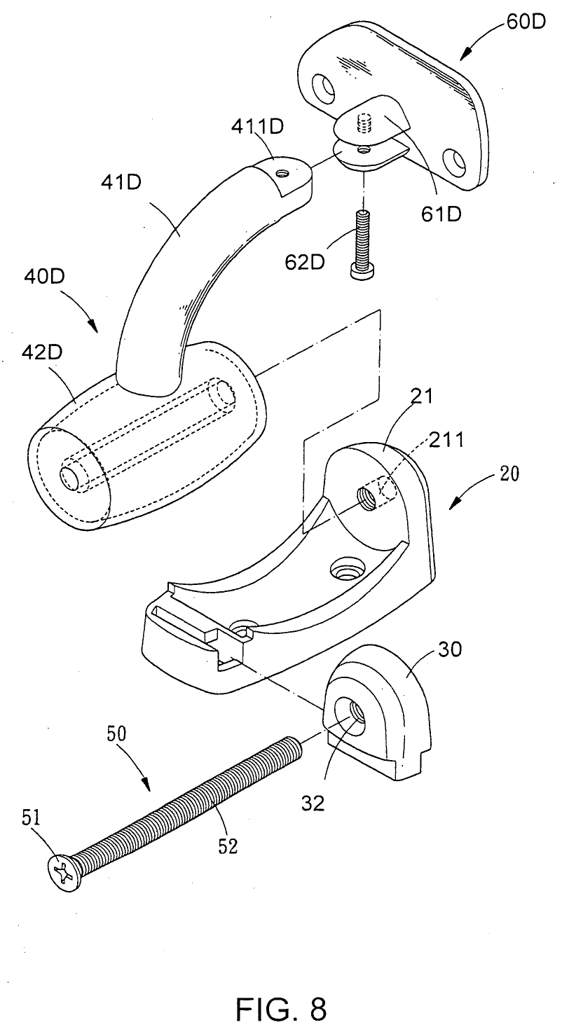

Referring to FIGS. 7-9, the bar support rack further comprises a pivot member 60D pivotally mounted on the rotation member 40D. The connecting portion 41D of the rotation member 40D is an arc-shaped rod and has a first end mounted on a periphery of the pivot portion 42D and a second end formed with a flattened mounting section 411D. The pivot member 60D has a first side pivotally mounted on the connecting portion 41D of the rotation member 40D and a second side for mounting a bar (not shown). The first side of the pivot member 60D is a formed with two wings 61D pivotally mounted on the mounting section 411D of the connecting portion 41D of the rotation member 40D by a locking screw 62D.

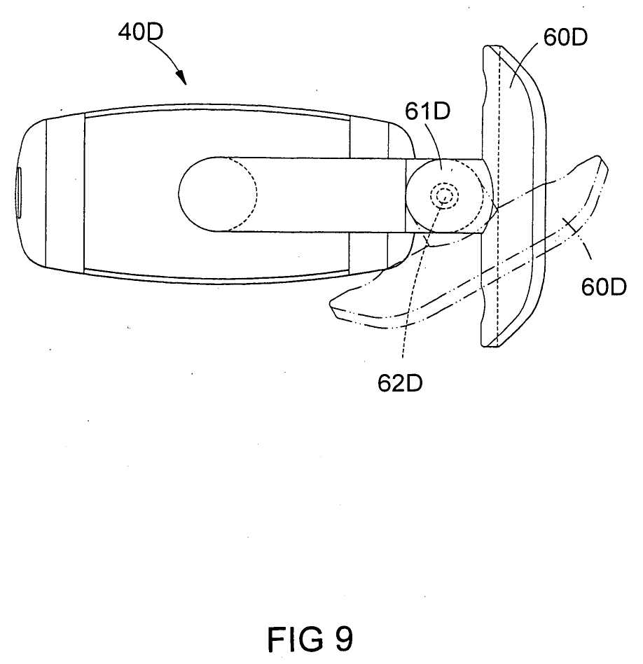

Referring to FIG. 9, when a user wishes to adjust the angle between the pivot member 60D and the rotation member 40D, the locking screw 62D is unscrewed, so that the pivot member 60D is rotatable relative to the rotation member 40D so as to adjust the angle between the pivot member 60D and the rotation member 40D. The locking screw 62D is tightened after the angle adjustment between the pivot member 60D and the rotation member 40D, so that the pivot member 60D is fixed on the rotation member 40D by the locking screw 62D.

Thus, the angle between the pivot member 60D and the rotation member 40D can be adjusted so as to adjust the position of the bar mounted on the pivot member 60D so that the inclined angle of the bar can be adjusted arbitrarily, thereby enhancing the versatility of the bar support rack.

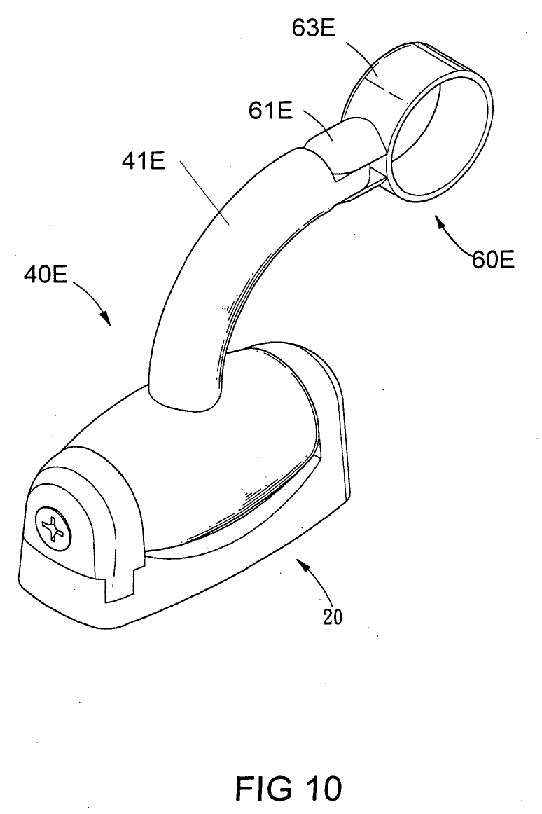

Referring to FIG. 10, the pivot member 60E has a first side 61E pivotally mounted on the connecting portion 41E of the rotation member 40E and a second side formed with a mounting ring 63E for mounting a bar (not shown).

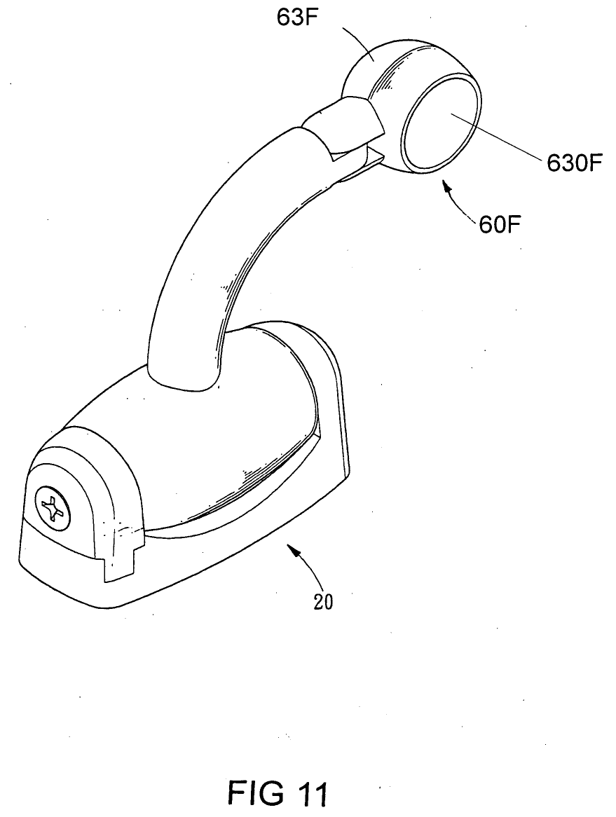

Referring to FIG. 11, the pivot member 60F has a second side formed with a mounting section 63F having an inside formed with an arc-shaped recess 630F for mounting a bar (not shown).

Accordingly, the angle between the rotation member and the base can be adjusted, and the angle between the pivot member and the rotation member can be adjusted so that the inclined angle of the bar mounted on the pivot member can be adjusted in a two-dimensional manner, thereby enhancing the versatility of the bar support rack.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A bar support rack, comprising:
a base;
a rotation member rotatably mounted on the base;
a locking member mounted between the base and the rotation member so that the rotation member is angle adjustably located on the base.

2. The bar support rack in accordance with claim 1, wherein the base has a first side formed with a first pivot ear and a second side formed with a locking slot, and the bar support rack further comprises a second pivot ear detachably mounted on the second side of the base and having a locking block mounted in the locking slot of the base.

3. The bar support rack in accordance with claim 2, wherein the second pivot ear has a side formed with a locking groove, and the locking slot of the base has a wall formed with a locking flange locked in the locking groove of the second pivot ear so that the second pivot ear is secured on the base.

4. The bar support rack in accordance with claim 2, wherein the rotation member includes a pivot portion pivotally mounted between the first pivot ear of the base and the second pivot ear and a connecting portion mounted on a periphery of the pivot portion.

5. The bar support rack in accordance with claim 4, wherein the first pivot ear of the base is formed with a transverse screw hole, the second pivot ear is formed with a transverse stepped screw bore axially aligning with the screw hole of the first pivot ear of the base, the pivot portion of the rotation member is formed with a through hole, and the locking member has a threaded rod extended through the screw bore of the second pivot ear and the through hole of the pivot portion of the rotation member and screwed into the screw hole of the first pivot ear of the base to secure the pivot portion of the rotation member between the first pivot ear of the base and the second pivot ear.

6. The bar support rack in accordance with claim 4, wherein the connecting portion of the rotation member is a tubular body.

7. The bar support rack in accordance with claim 1, wherein the rotation member is a substantially T-shaped hollow body.

8. The bar support rack in accordance with claim 5, wherein the locking member has an end formed with an enlarged head located in the screw bore of the second pivot ear.

9. The bar support rack in accordance with claim 1, wherein the angle between the rotation member and the base is adjusted by the locking member.

10. The bar support rack in accordance with claim 4, wherein the connecting portion of the rotation member has a first end mounted on a periphery of the pivot portion and a second end formed with a mounting ring.

11. The bar support rack in accordance with claim 4, wherein the connecting portion of the rotation member has a first end mounted on a periphery of the pivot portion and a second end formed with a mounting section having an inside formed with an arc-shaped recess.

12. The bar support rack in accordance with claim 4, wherein the first pivot ear of the base is formed with a transverse mounting hole, and the pivot portion of the rotation member has a first end formed with a protruding post inserted into the mounting hole of the first pivot ear of the base.

13. The bar support rack in accordance with claim 12, wherein the second pivot ear is formed with a transverse stepped screw bore axially aligning with the mounting hole of the first pivot ear of the base, the pivot portion of the rotation member has a second end formed with a screw bore, and the locking member has a threaded rod extended through the screw bore of the second pivot ear and screwed into the screw bore of the pivot portion of the rotation member to secure the pivot portion of the rotation member between the first pivot ear of the base and the second pivot ear.

14. The bar support rack in accordance with claim 1, further comprising a pivot member pivotally mounted on the rotation member.

15. The bar support rack in accordance with claim 14, wherein the rotation member includes a pivot portion pivotally mounted on the base and a connecting portion having a first end mounted on a periphery of the pivot portion, and the pivot member has a first side pivotally mounted on the connecting portion of the rotation member.

16. The bar support rack in accordance with claim 15, wherein the connecting portion of the rotation member has a second end formed with a flattened mounting section, and the first side of the pivot member is a formed with two wings pivotally mounted on the mounting section of the connecting portion of the rotation member by a locking screw.

17. The bar support rack in accordance with claim 16, wherein the angle between the pivot member and the rotation member is adjusted by the locking screw.

18. The bar support rack in accordance with claim 15, wherein the pivot member has a second side formed with a mounting ring.

19. The bar support rack in accordance with claim 15, wherein the pivot member has a second side formed with a mounting section having an inside formed with an arc-shaped recess.

20. The bar support rack in accordance with claim 14, wherein the angle between the rotation member and the base is adjusted, and the angle between the pivot member and the rotation member is adjusted so that the inclined angle of the pivot member is adjusted in a two-dimensional manner.
